(19) United States
(12) Patent Application Publication
(10) Pub. No.: US 2008/0000364 A1
(43) Pub. Date: Jan. 3, 2008

(54) Golf ball locating system and methods of use

(76) Inventor: Dennis Paul Bevirt, Belleville, IL (US)

Correspondence Address: Dennis Paul Bevirt, 1535 North Charles Street, Belleville, IL, 62221, US

(21) Appl. No.: 11/473,811

(22) Filed: Jun. 23, 2006

(51) Int. Cl. B41F 17/00

(52) U.S. Cl. 101/35

(57) ABSTRACT

A method and a golf ball locating system enable a golfer to easily find a “lost” ball. The method for playing golf includes providing a golf ball that complies with golf ball specifications of the United States Golf Association, wherein the golf ball has a construction that is of at least a two-piece construction, providing the golfer with a writing instrument that contains a magnetic ink composition, and placing a mark across an outer surface of the golf ball using the writing instrument. The method also includes striking the golf ball with at least one golf club, and locating the golf ball using a handheld transmitting/receiving device that is programmed to detect the mark written on the golf ball from a distance of at least twenty feet away from the golf ball.

### BACKGROUND OF THE INVENTION

This invention relates generally to golf balls, and more particularly, to methods and apparatus for systems for use in locating golf balls.

In recent years, the increase in the popularity of golf has spurred an increased demand for innovative equipment and golf course features. For example, in recent years, golf clubs have been developed that generally enable golfers to drive golf balls farther than in past years. However, depending on the topography of the golf course and/or the weather conditions, long drives may result in losing visual contact with the ball. As a result, golfers may lose golf balls without any practical means to locate them, other than visual observation. In addition to the expense of replacing the lost ball, according to the rules of the U.S. Golf Association, a player is penalized for strokes in a round or game of golf if his/her golf ball is lost. In addition, because of the increased popularity of the sport, golf courses often impose time limits upon play because of the number of other players waiting to play. Such time limits may not provide golfers with sufficient time to visually inspect all areas of the course for lost balls.

To facilitate locating lost golf balls, several patents have issued which are directed to methods of golf ball locating systems. For example, German Pat. No. G 87 09 503.3 describes a multi-piece golf ball that includes foil reflectors glued to an outer layer of a core of the ball. Each reflector includes a two part foil antenna with a diode connected on the inner ends. The ball may be found when a reflected signal, generated by the foil antenna and diode, is reflected back toward a receiver. However, generally the arrangement of the reflectors and diodes on the ball in this German patent may cause the ball to have poor durability and also may increase the difficulty and expense associated with manufacturing the ball. For example, the impact of a club striking such a ball may cause the ball to rupture due to the interruption of the shell/core interface by the foil reflectors. Furthermore, such reflectors may also adversely affect the driving distance of such a ball.

Other known golf ball locating systems describe golf ball manufacturers positioning other locating devices within the core of the golf ball. For example, U.S. Pat. No. 5,132,622 describes the insertion of a metal center within the core of the golf ball, and U.S. Pat. No. 6,904,000 describes the insertion of an active Radio Frequency Identification Device (RFID) within the core of the golf ball. Again, the inclusion of such devices within the golf ball core may adversely affect the driving distance and/or the rolling accuracy of the ball. Other known locating systems describe methods by which golf ball manufacturers have attempted to include locating features that extend across a portion of an external surface of the balls. For example, U.S. Pat. No. 6,676,538 describes coating a portion of the exterior surface of the golf ball with a metal powder and a clear protective coating to facilitate the likelihood of a golfer seeing the ball after driving it. However, as described above, the likelihood of finding such a ball is still limited to visual observation.

### BRIEF SUMMARY OF THE INVENTION

In one aspect, a golf ball is provided. The golf ball includes a ball body, and at least one mark written on a surface of the ball body by a user, wherein each mark contains a magnetic ink composition.

In another aspect, a golf ball locator system includes a golf ball including a ball body, a writing instrument, and a handheld transmitting/receiving device. The writing instrument includes a magnetic ink composition and is configured to enable a user to write a mark across an outer surface of the golf ball. The handheld transmitting/receiving device is configured to detect the mark written on the golf ball from a distance of at least twenty feet away from the golf ball.

In a further aspect, a method for playing golf includes providing a golf ball that complies with golf ball specifications of the United States Golf Association, wherein the golf ball has a construction that is of at least a two-piece construction, providing the golfer with a writing instrument that contains a magnetic ink composition, and placing a mark across an outer surface of the golf ball using the writing instrument. The method also includes striking the golf ball with at least one golf club, and locating the golf ball using a handheld transmitting/receiving device that is programmed to detect the mark written on the golf ball from a distance of at least twenty feet away from the golf ball.

### BRIEF DESCRIPTION OF THE DRAWINGS

FIG. 1 is a partial cut-away view of an exemplary golf ball marked by a golfer to facilitate identifying the ball as their own and to facilitate finding the ball, if lost; and

FIG. 2 is a front view of an exemplary handheld transmitting/receiving device that may be used to locate the golf ball shown in FIG. 1.

### DETAILED DESCRIPTION OF THE INVENTION

As used herein, an element or step recited in the singular and proceeded with the word “a,” “an,” or “one” (and especially, “at least one”) should be understood as not excluding plural said elements or steps, unless such exclusion is explicitly stated. Furthermore, references to “one embodiment” (or to “other embodiments”) of the present invention are not intended to be interpreted as excluding either the existence of additional embodiments that also incorporate the recited features or of excluding other features described in conjunction with the present invention. Moreover, unless explicitly stated to the contrary, embodiments “comprising” or “having” an element or a plurality of elements having a particular property may include additional such elements not having that property.

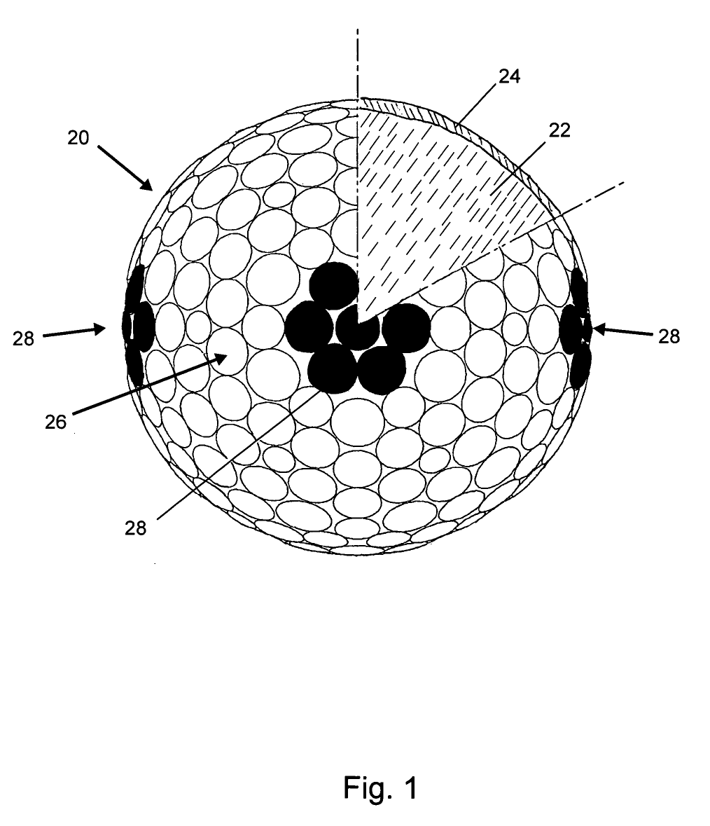

FIG. 1 is a partial cut-away view of an exemplary golf ball 20 marked by a golfer (not shown) to enable the ball to be easily identified as their own, and to facilitate the golfer finding the ball 20 during a round of golf. In the exemplary embodiment, golf ball 20 includes a ball core 22 and a cover 24 that extends over core 22 such that ball core 22 is encased within cover 24. Specifically, in the exemplary embodiment, ball 20 is a two-piece golf ball produced by molding a natural resin, such as balata, or a synthetic resin, such as thermoplastic resin, polymeric cover composition around a preformed polybutadiene, such as rubber, core 22. During the molding process, as is known in the art, a desired dimple pattern 26 is molded into the cover material. Within at least some known golf ball manufacturing methods, a color pigment, a dye, and/or an optical brightener is added directly to the generally “off white” colored polymeric cover composition prior to molding. In an alternative embodiment, ball 20 is a multi-layered ball 20 that includes one or more intermediate or cover layers 24 molded around a generally solid core 22. In a further alternative embodiment, ball 20 is at least a two-piece constructed ball 22. In each embodiment, ball 20 is within specifications regulated by the United States Golf Association (U.S.G.A.).

In use, ball 20 is marked in a desired marking 28 by a golfer using a writing instrument (not shown) containing an ink composition that facilitates the ball being located by the golfer as is described in more detail below. Specifically, in the exemplary embodiment, ball 20 is marked by a writing instrument that contains a known aqueous magnetic ink composition. To facilitate preventing the ball from resting only on a single marking, in the exemplary embodiment, the ball 20 is marked on several diametrically opposed locations on the outer surface of cover 24 with the ink composition. In an alternative embodiment, ball 20 is marked with a non-aqueous ink composition. The ink solution may include any combination of, but is not limited to including, humectants, surfactants, dispersion aides, biocide and/or fungicide components. Specifically, such components are for the most part, known in the industry and when combined in accordance with known techniques for ink processing, create ink compositions that are magnetic, such as those used with magnetic ink character recognition (MICR) applications that contain a conductive metal oxide component.

When the ink composition is magnetized, at least some particles suspended within the ink composition are substantially aligned such that a specific magnetic charge is imparted to the magnetic component of the ink composition. The capability of a magnetic material to retain the imparted charge, or the magnetic induction that remains in the ink composition, is referred to as remanence, Mᵣ. Generally, the remanence increases with an increase in the particle size of the magnetic material. However, as is known in the art, the larger the particle size the more difficult it is to maintain the particle in suspension within an ink composition. As such, in the exemplary embodiment, to facilitate producing ink compositions that contain small particle size magnetic material, the magnetic component loading is increased during manufacturing of the ink composition.

In the exemplary embodiment, the remanence of the ink composition is selected to be at least 80 emu/g. The higher the remanence value the stronger the locatable/readable signal. In the exemplary embodiment, the ink composition includes magnetic iron oxide particles that are sized to exhibit and retain the proper magnetic properties within the aqueous ink composition. Alternatively, other iron oxide concentrations, other magnetic component loading, or other magnetic particles may be used to facilitate producing an ink composition having a remenance higher or lower than 80 emu/g. For example, an ink composition exhibiting a higher remanence will generally require less total percent iron oxide in the composition, and the iron oxide particles contained therein may have improved suspension properties in comparison to an ink composition having a lower remanence and a higher percent iron oxide content. Moreover, in the exemplary embodiment, the iron oxide particles have good dispersibility and good hydrophilic suspension properties.

Although in the exemplary embodiment, magnetite or synthetic magnetic iron oxide is the preferred magnetic component for use with the ink composition, there are other materials that may be employed without limiting the scope of the present invention. As such, as will be appreciated by one of ordinary skill in the art, any reference to an iron oxide component is equally applicable to other metal oxides and metal-containing compounds, such as, but not limited to, zinc, magnetite, cobalt, chromium, copper, vanadium, aluminum, cobalt, nickel, silver, and magnesium. In an alternative embodiment, the ink composition includes any particle matter, including non-iron oxide components, that enables golf ball 20 to function as described herein.

In the exemplary embodiment, a coating is applied to the iron oxide particles to facilitate maintaining the iron oxide in suspension for a longer time within the ink composition. Moreover the coating imparts to the oxide particles a tendency to remain separate within the ink composition, to decrease the possibility of the particles agglomerating, and to increase the dispersibility of the ink composition. For example, the coating may be, but is not limited to being aluminum silicate, sodium silicate, potassium silicate, cupric silicate, and/or other inorganic silicates. Other coatings may include, but are not limited to including, metallic stearates, metallic phosphate esters, metallic sulfonites and other similar compounds.

It should be noted that other known additives and/or components may added to the ink composition. For example, the ink composition may also include, but is not limited to including, surfactants, colorants, humectants, dyes, pigment stabilizers, buffering agents, biocides, and/or water-soluble resins. In other embodiments, a dispersant may be added to the ink composition to facilitate enhancing the suspension of the iron oxide particles. In each embodiment, when the ink composition is applied across a portion of the exterior surface of cover 24, the resulting ball has substantially the same weight and size as a ball which complies with the United States Golf Association specifications. Moreover, in each embodiment, the ink composition is contained within a writing instrument that enables the golfer to write a unique mark, i.e., his or her initials, upon the ball that facilitates the ball being easily visually identified.

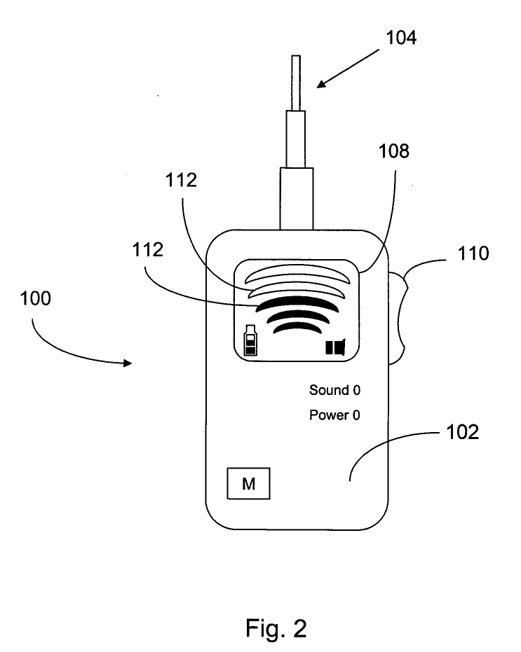

FIG. 2 is a front view of an exemplary handheld transmitting/receiving device 100 that may be used to locate golf ball 20 (shown in FIG. 1). It should be noted that device 100 is exemplary only, and that the other embodiments of handheld transmitting/receiving devices may be used to locate golf balls 20. In the exemplary embodiment, device 100 is compliant with all regulations of the Federal Communications Commission and is a battery-powered device that includes a detection means mounted within a housing 102.

In one embodiment, device 100 operates using a modified pulse induction technology and a beat-frequency oscillator. Housing 102 includes a plurality of transmitters, receivers, and at least two induction coils of wire. Initially, to facilitate detection of ball 20 from a greater distance, at least one coil of wire is electrically coupled to an oscillator that generates thousands of pulses of current per second. As the pulses travel through each coil, radio waves are generated and are transmitted through a directional antenna 104 extending from housing 102. As reflected radio waves are received, the wavelength of each reflected radio wave is compared by a detection circuit to a pre-determined wavelength based on the properties of the ink composition, and the detection circuit can detect balls 20 marked with the ink composition described above. In the exemplary embodiment, antenna 104 is retractable into housing 102. Alternatively, other directional antennas may be used. Specifically, the detection circuit provides the user with a general location for the ball and provides an audio and/or visual indication that the directional antenna 104 is pointed in the general direction of the ball 20. As defined herein, a user is an individual, such as a golfer, that intends to use the golf ball in play and only has the ability to form a desired marking on an external surface of the golf ball cover 24, as opposed to a manufacturer which has the capability of embedding a component within the golf ball core.

As the user approaches the ball, a processor within device 100 causes short pulses of current to be transmitted through at least one coil of wire. The term processor, as used herein, refers to microprocessors, application specific integrated circuits (ASIC), logic circuits, and any other circuit or processor capable of executing system 60 as described herein. Specifically, device 100 includes a pulse generator connected to at least one coil for generating a time changing magnetic field in response to electrical pulses applied to the coil. Each pulse generates a brief magnetic field. When each pulse ends, the magnetic field reverses polarity and collapses, resulting in a sharp electrical spike. This spike lasts a few microseconds (millionths of a second) and causes another current to run through the coil. This current is called the reflected pulse and is extremely short, lasting only about thirty microseconds. Another pulse is then sent and the process is repeated.

During use, a sampling circuit in device 100 is programmed to monitor the length of each reflected pulse. By comparing the wavelength of each reflected pulse to an expected wavelength based on the properties of the ink composition, the circuit can detect balls 20 marked with the ink composition described above. For example, when in the vicinity of a ball 20, the reflected pulse takes longer to decay. Specifically, in the exemplary embodiment, a resistive energy damper is coupled to at least one induction coil for attenuating the energy in the magnetic field in a manner which extends the decay of the current in the coil after termination of the pulse.

The sampling circuit sends signals indicative of the detection of ball 20 and the magnitude of an induction coil current at sampling time to an integrator. The integrator receives the signals from the sampling circuit, amplifies the signals, and converts the signals to direct current (DC). A signaling circuit is connected to the output of the sampling circuit for signaling changes in the detected coil current as device 100 is moved. The signaling circuit transmits a signal indicative of whether the coil current increases, decreases or remains substantially the same. The direction of change, or the lack of change in the coil current as the coil is moved, may then be interpreted by the user, as an indication of the location of ball 20. The direct current's voltage is connected to an audio circuit, wherein the voltage is changed within an audio interface into an audible tone that may be broadcast from device 100. In the exemplary embodiment, the audible tone is selectively activatable such that the audio option may be turned off while on the golf course if desired. More specifically, the audio interface may optionally be an earphone rather than a speaker, and as an option, the handheld unit 100 may utilize a vibrating transducer to alert the user to the presence of ball 20. A visual display 108, such as a meter or a string of light emitting diodes, LEDs, may also provide a proximity measure to the user so that the user can tell whether or not the user is getting closer to the ball or further from the ball as the user walks around searching for ball 20. Display 108 also includes a useful battery-life indicator.

A thumb activated pushbutton switch 110 is used to turn device 100 on. The device 100 is sized to enable a golfer to easily operate it with one hand while carrying a golf bag or club in the other. For a normal method of use, a golfer would depress thumbswitch 110 and sweep the device 100 from left to right until the most “positive” tone was heard. This could be the loudest tone. In other words, when the antenna 102 is pointed in the vicinity of the golf ball 20, the highest volume of audio signal should be generated. Alternatively, the visual display 108 will indicate when the antenna 102 is pointed in the vicinity of the golf ball 20. As described above, once within the vicinity of the golf ball 20, the processor will then cause short pulses of current to be transmitted through at least one coil of wire and begin monitoring the reflected pulses. When the device 100 is in the vicinity of a ball 20, the reflected pulse takes longer to decay. Specifically, in the exemplary embodiment, a resistive energy damper is coupled to the coil for attenuating the energy in the magnetic field in a manner which extends the decay of the current in the coil after termination of the pulse.

In addition to the processor, transmitters, and receivers, device 100 also includes a memory which, in at least certain embodiments, includes adaptive threshold software which causes the processor to perform the locating methods described herein. It will be appreciated that the software may be stored within the processor itself or that the processor may implement the methods of determining adaptive thresholds using hardware circuitry only, rather than relying upon software. Display 108 may be a liquid crystal display which can display signal strength by displaying a number of indicator bars 112 which illuminate depending upon the level of the signal strength. The sound generator may produce beeps at a certain pitch and at a certain rate of repetition to indicate a relative distance to golf ball 20. For example, low pitches at a low rate of repetition may indicate that the user is a greater distance to golf ball 20, and a high pitch with a high rate of repetition may indicate that device 100 is closer to golf ball 20.

The above-described golf ball locating device provide a user with a means to quickly mark a golf ball cover with a marking that enables the golfer to easily visually identify the golf ball, and that facilitates the golfer finding the ball. Specifically, the golfer is provided with a writing instrument that contains a magnetic ink composition. After contacting the ball during a round of golf, the golfer utilizes a handheld transmitter/receiver to locate the ball. Initially, radio waves enable the golfer to identify the general vicinity of the golf ball and then a processor monitors changes to a magnetic field to identify a more specific location of the golf ball. As a result, a golf ball locating system is provided which facilitates increasing the speed of golf rounds and decreases the likelihood of a golfer losing a ball during a round of golf in a cost-effective and reliable manner.

Exemplary embodiments of golf balls and locator systems are described above in detail. Although the locator systems are herein described and illustrated in association with specific ink compositions, it should be understood that the present invention may be used to locate golf balls marked with a variety of magnetic ink compositions. Moreover, it should also be noted that the components of each locator system are not limited to the specific embodiments described herein, but rather, aspects of each golf ball and/or locating system method may be utilized independently and separately from other methods described herein.

While the invention has been described in terms of various specific embodiments, those skilled in the art will recognize that the invention can be practiced with modification within the spirit and scope of the claims.

What is claimed is:

1. A golf ball comprising:
a ball body; and
at least one mark written on a surface of the ball body, wherein the mark contains a magnetic ink composition.

2. A golf ball in accordance with claim 1 wherein the magnetic ink composition comprises a metal oxide pre-dispersion and an aqueous ink composition.

3. A golf ball in accordance with claim 2 wherein the metal oxide pre-dispersion comprises at least one of iron, zinc, magnetite, chromium, copper, vanadium, aluminum, cobalt, nickel, silver, and magnesium.

4. A golf ball in accordance with claim 2 wherein the magnetic ink composition further comprises a coloring pigment.

5. A golf ball in accordance with claim 2 wherein the magnetic ink composition further comprises a radioluminescent material.

6. A golf ball in accordance with claim 1 wherein the magnetic ink composition exhibits a remanence value of at least approximately 50 emu/g.

7. A golf ball in accordance with claim 1 wherein the ball body comprises a core and a cover encasing the core.

8. A golf ball locator system comprising:
a golf ball comprising a ball body;
a writing instrument configured to enable a user to write a mark across an outer surface of the golf ball, the writing instrument comprising a magnetic ink composition; and
a portable transmitting/receiving device configured to detect the mark written on the golf ball from a distance of at least twenty feet away from the golf ball.

9. A golf ball locator system in accordance with claim 8 wherein the writing instrument magnetic ink composition comprises a metal oxide pre-dispersion and an aqueous ink composition.

10. A golf ball locator system in accordance with claim 9 wherein the metal oxide pre-dispersion comprises at least one of iron, zinc, chromium, magnetite, copper, vanadium, aluminum, cobalt, nickel, silver, and magnesium.

11. A golf ball locator system in accordance with claim 9 wherein the writing instrument magnetic ink composition exhibits a remanence value of at least approximately 20 emu/g after the mark is applied to the golf ball.

12. A golf ball locator system in accordance with claim 9 wherein the golf ball body comprises a radioluminescent material.

13. A golf ball locator system in accordance with claim 9 wherein the golf ball body comprises at least a two-piece construction.

14. A golf ball locator system in accordance with claim 9 wherein the handheld transmitting/receiving device is battery powered.

15. A golf ball locator system in accordance with claim 14 wherein the handheld transmitting/receiving device comprises a battery useful-life indicator.

16. A golf ball locator system in accordance with claim 9 wherein the handheld transmitting/receiving device is configured to provide to the user at least one of a visual display indicative of a location of the golf ball, and an audible alarm indicative of a location of the golf ball.

17. A method for playing golf comprising:
providing a golf ball that complies with golf ball specifications of the United States Golf Association, wherein the golf ball has a construction that is of at least a two-piece construction;
providing the golfer with a writing instrument that contains a magnetic ink composition;
placing a mark across an outer surface of the golf ball using the writing instrument;
striking the golf ball with at least one golf club; and
locating the golf ball using a handheld transmitting/receiving device that is programmed to detect the mark written on the golf ball from a distance of at least twenty feet away from the golf ball.

18. A method in accordance with claim 17 wherein locating the golf ball further comprises providing the user, via the handheld transmitting/receiving device, at least one of an audible alarm and a visual display that is indicative of a location of the golf ball.

19. A method in accordance with claim 17 wherein locating the golf ball further comprises providing the user, via the handheld transmitting/receiving device, at least one of an audible alarm and a visual display that is indicative of an amount of useful life of the batteries providing power to the handheld transmitting/receiving device.

20. A method in accordance with claim 17 further comprising reapplying the mark during the golf match using the pen.
